(19) United States
(12) Patent Application Publication
(10) Pub. No.: US 2008/0304257 A1
(43) Pub. Date: Dec. 11, 2008

(54) Lamp

(76) Inventor: Rainer Opolka, Solingen (DE)

Correspondence Address: K.F. ROSS P.C., 5683 RIVERDALE AVENUE, SUITE 203 BOX 900, BRONX, NY, 10471-0900, US

(21) Appl. No.: 12/159,864

(22) PCT Filed: Oct. 31, 2006
(86) PCT No.: PCT/DE2006/001912

§ 371 Date: Jul. 2, 2008

(30) Foreign Application Priority Data
Jan. 4, 2006 (DE) 202006000063.1
Jun. 16, 2006 (DE) 202006009412.1

(51) Int. Cl. F21L 4/00

(52) U.S. Cl. 362/191; 362/194

(57) ABSTRACT

The invention relates to a lamp having a light source, a holder for accommodating a battery and means for providing a closed circuit, wherein the holder comprises a plastic body (10, 20, 30, 40, 50), which has a fastening means, preferably a drilled hole (204) or a pin element (42) for connecting a lamp head (16), also at least one drilled hole (202) for fixing an arm (11) in a friction-locking or interlocking manner with an end-side fastening means (13, 14) and two exposed contacts (16, 17; 31; 41), which can be connected detachably to the contacts of a single battery.

### CROSS REFERENCE TO RELATED APPLICATIONS

This application is the US national phase of PCT application PCT/DE2006/001912, filed 31 Oct. 2006, published 12 Jul. 2007 as WO 2007/076736, and claiming the priority of German patent application 202006000063.1 itself filed 4 Jan. 2006 and PCT patent application PCT/DE2006/001912 itself filed 31 Oct. 2006, whose entire disclosures are herewith incorporated by reference.

The invention relates to a light fixture with a light source, a holder for accommodating a battery, and a means for forming a closed circuit.

A prior-art flashlight is known that, as a portable light source, includes a housing for accommodating the batteries as well as a socket into which a light bulb may be screwed and that may be switched on and off via a push or slide switch.

As the light output of light-emitting diodes (LED's) improves through continued technical development, the scope of applications for LED's increases. In fact, LED's have recently been developed whose luminosity is equal to or even exceeds that of incandescent bulbs. The advantages of a LED stem first from their far lower energy use, secondly from their long life, and finally from their resistance to damage from impact and shock. Because LED's are also relatively small, it is also possible to create small flashlights. However, in existing light fixtures, the closed housing is standard.

In home lighting fixtures, in addition to purely functional light fixtures, there are also decorative light fixtures that emit only a low level of light in order to provide a certain minimal lighting in a hallway or to serve as a television light. This category also includes strings of lights as well as lighting arrangements that are provided with a stand or may be fixed to a window pane by means of a suction cup.

The disadvantage of all of the lights described above lies in the fact that these lights are inflexible and sometimes structurally complex.

The object of the present invention is therefore to create a light fixture of the type described above that is easy to handle, has an altered design, and has a simple structure.

This object is attained by the light fixture according to claim 1, which according to the invention is characterized in that the holder comprises a plastic body having a fastening means, preferably a hole or a pin for connecting a light fixture head, as well as at least one hole for attaching an arm in a positive or frictionally engaged manner having a fastening means on one end and two exposed contacts that may be connected to the contacts of a single battery in a detachable fashion. In contrast to embodiments known from the prior art, the light fixture according to the invention does not have a battery housing; rather, it has only a holder to whose outside surface a battery may be attached via the fastening means provided there in such a way that the light source is supplied with power from the battery via existing contacts. The battery body remains visible from the outside and may thus be easily removed by pulling back the contacts or be replaced. The plastic body itself may have very small dimensions because it serves only as a connecting means for the light fixture head and attachable arms or legs. By virtue of its simple structure, production costs are reduced to a minimum.

Further developments of the invention are described in the dependent claims.

According to a first embodiment, the exposed contacts include two contact clips on the outside surface of the plastic body for attaching a block battery. The contacts themselves and the block battery as well as its connection to such contacts are fundamentally known from the prior art; however, up to now a closed battery container has been used to hold the block battery.

As an alternative to this, the exposed contacts may include a contact point on an outside surface of the plastic body on one side and a hook on the other side, with the battery clamped detachably between the contact point and the exposed leg of the hook. Here, a conventionally shaped battery may be accommodated in the holder. In order to improve the attachment of such a battery, the exposed leg is shaped as a spring element that clamps the battery under spring pressure. In principle, the hook is composed of a bent piece of sheet metal.

According to another embodiment of the present invention, the light fixture head is arranged in the plastic housing in a rotatable fashion and the light source may be switched on and off by rotating the light fixture head. This may occur, for example, via available pin contacts in contact guides.

The light source itself may be an incandescent lamp. Preferably, however, a LED or a set of LED's arranged in the light fixture head is used.

In another embodiment according to the present invention, the light fixture head, which is provided with at least one LED, has a metallic thread as well as a contact point on its lower end; by screwing this thread into a correspondingly formed thread on the holder, the circuit may be closed or opened.

Moreover, the plastic body may have an L-shape, with its short leg carrying the light-fixture head and the contacts and the long leg being used as a support surface for the inserted batteries. The latter embodiment is preferably used in light fixtures in which the light fixture itself is intended to represent a humanoid figure, which will be discussed in greater detail below.

As was already mentioned at the outset, the light fixture has at least one arm secured in a drilled seat. At the end of this arm, a fastening means is arranged that may in particular be comprised of a suction cup or a magnet. Thus, it is possible for the battery-operated light fixture to be attached to glass surfaces, in particular to panes, in any manner; the same also applies to ferromagnetic surfaces to which a magnet would adhere.

It is also possible for at least one arm to have a alligator clip or two opposing jaws on its end for the purpose of attaching small sheets of paper, notes, business cards, or the like.

Preferably, the light fixture body is embodied as a humanoid figure with arms and/or legs and a head, with the battery forming the body along with the plastic part. Such figures may, for example, have the light fixture head as the head of the figure and the plastic part with the battery as the torso of the body, from which two arms and two legs or four legs extend. The arms and legs are preferably made flexible so as to be easily bendable into various physical poses. For example, the arms and legs may have suction cups or magnets on their ends, optionally in an exchangeable fashion. According to a particular embodiment, the legs are provided with magnets or suction cups, while the arms have alligator clips or other clamps.

Further embodiments of the present invention are shown in the drawing. Therein:

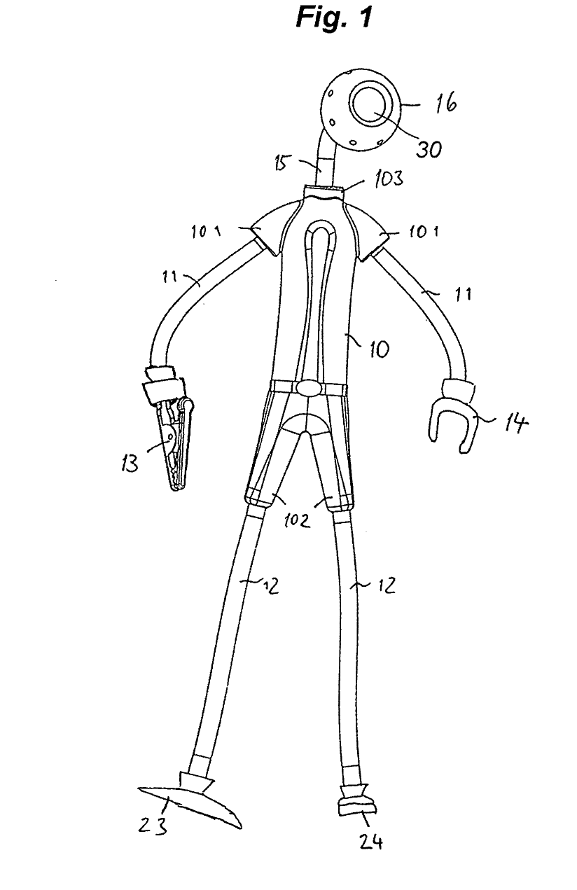

FIG. 1 is a perspective view of a humanoid lamp,

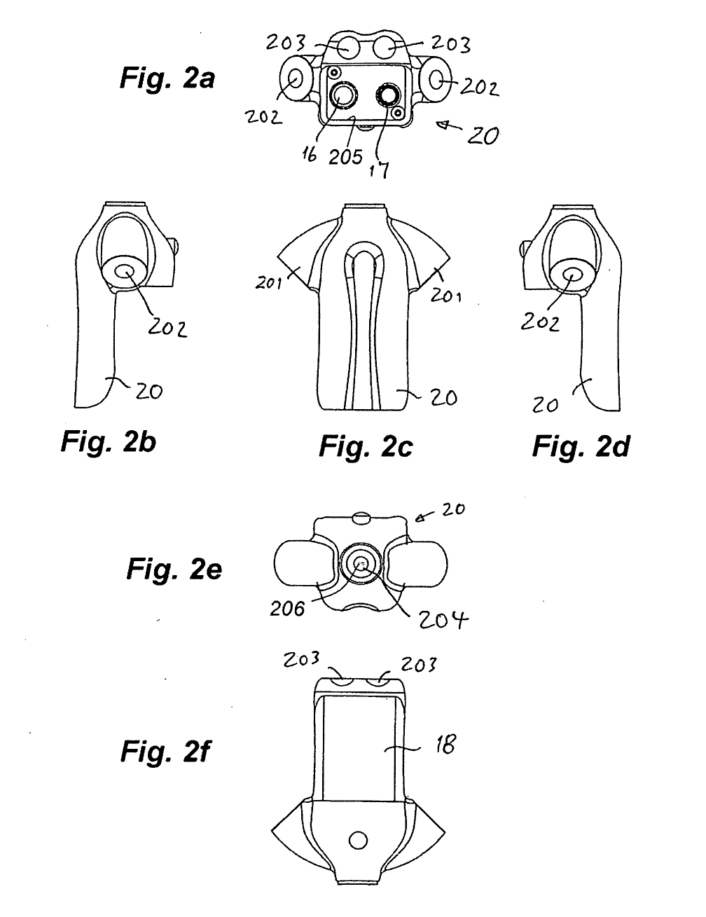

FIGS. 2a-2f,

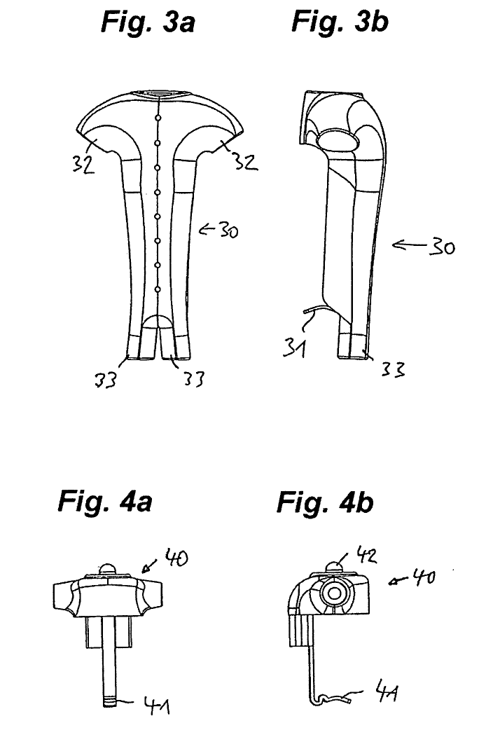

FIGS. 3a and b,

FIGS. 4a and b, and

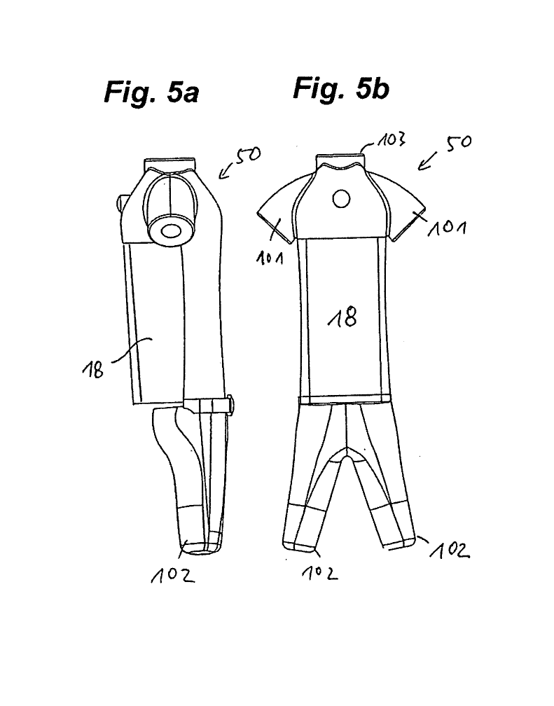

FIGS. 5a and b are further embodiments of plastic bodies in various views.

As seen in FIG. 1 a humanoid figure composed of a plastic body 10 is in the form of the torso of a humanoid body having arm sockets and leg sockets in which are fitted arms 11 and legs 12. In the case shown in FIG. 1, the plastic body 10 has holes in the sockets 101 and 102 into which inner ends of the arms 11 and the legs 12 are detachably plugged. At the outer ends of the arms 11 are either an alligator clip 13 or a stiff claw 14 for the holding notes or stacks of letters. The outer ends the legs 12 carry either magnets 24 (in the shape of shoes) or suction cups 23. The plastic body 10 has an upwardly directed head socket 103 formed with a hole into which a neck 15 with interior power connections is fitted and carrying on an outer end a head 16 in which is mounted a light source 30 has been inserted, on the end of which a light fixture head 16 is located in which an LED is preferably arranged as an energy-saving light source.

One alternative to the plastic body 10 according to FIG. 1 is shown in detail in FIGS. 2a-f. The plastic body 20 there is a short torso with shoulder stumps 201 with holes 202 for the insertion of arms 11. The plastic body 20 also has corresponding holes 203 on its lower end for insertion of the legs 12.

Snap contacts 16 and 17 in the shoulder region fit with complementary poles of a 9V block battery. As shown by FIG. 2f, the battery 18 is held against the back of the plastic body 20. The top view in FIG. 2e shows that a hole 204 is provided on the collar-shaped upper socket 204 into which the neck piece 15 may be inserted, with this hole having contacts supplying current to the light fixture head 16. FIG. 2 shows a further variant of a plastic body 30 having a hook 31 that serves as a lower contact for the negative pole of an AA cell-type battery whose positive pole bears against an upper contact of the plastic body 30. Arm stumps 32 and leg stumps 33, with corresponding holes, serve as attachment means for arms 11 and legs 12. The arms 11 and legs 12 as well as the neck 15 are preferably flexible so the fixture can be posed.

A minimal version of a plastic body 40 is shown in FIGS. 4a and b. This body is essentially L-shaped in cross section and has a hook 41 that serves as an electrical contact and against which a lower pole of a battery rests. This hook 41 is attached in the plastic body 40, which has another electrical contact that, when a battery is inserted, fits with the upper positive pole of this cell-type battery. This latter contact is electrically connected to a metal pin 42. The metal pin 42 also serves as attachment means for a neck piece 15 or a light fixture head 16.

FIGS. 5a and b show a shape of a plastic body 50 for accommodating a block battery 18. The plastic body has shoulder stumps 101, a neck piece 103, and leg stumps 102, to which the corresponding description for FIG. 1 applies.

All of the plastic bodies serve as holders for batteries, with the plastic bodies also being adapted to the different types of batteries with regard to the position of the electrical contacts. Fastening means are provided for the attachment of legs, arms, and a neck; they may be embodied in the form of a hole that accommodates parts inserted into it in the manner of a frictionally engaged connection. Instead of this, threaded holes may also be provided into which corresponding external threads on the end pieces of the arms, legs, and neck piece may be screwed.

In the simplest case, the circuit into which one or more LED's are integrated in the light-fixture head 16 is closed by the insertion or clamping in place of the batteries. In an alternate version, however, the light fixture head 16 may also be embodied in such a way that it is possible to open and close the circuit by turning the light fixture head. The light fixture head 16 may be essentially spherical, as shown, or have some other shape. The light fixture head may have a single aperture or be transparent, if illumination in all directions is desired.

The particular advantage of the present light fixture lies in the fact that the light fixture is structured as a humanoid figure in a toy-like form, may be operated by battery, and has a simple structure. The magnetic feet 24 or suction cups 23, which are preferably interchangeable, allow for attachment to metal objects or panes of glass, wardrobe walls, or similar smooth surfaces and for the attachment to be changed at will. Preferably, the alligator clips 13 or other gripping mechanisms 14 provided at the end of the arms 11 are also interchangeable, i.e., attached in a detachable manner, which further increases the variety of forms

1-12. (canceled)

13. A light fixture comprising:
a body provided with upper arm fasteners and lower leg fasteners and having an exposed holder surface;
arms and legs releasably connectable to the respective fasteners;
fastening means on outer ends of the legs;
a head mounted atop the body
an electric light source in the head;
a battery;
two contacts fixed in the body and oriented to hold the battery against the holder surface; and
circuitry between the contacts and the light source for powering the light source from the battery.

14. The light fixture defined in claim 13 wherein the contacts comprise a pair of adjacent male and female button contacts, the battery being a block battery.

15. The light fixture defined in claim 13 wherein the contacts comprise a downwardly directed upper contact and a hook forming the lower contact, the battery being a cell-type battery with end poles.

16. The light fixture defined in claim 15 wherein the hook is vertically elastically deflectable.

17. The light fixture defined in claim 13 wherein the head is rotatable on the body, the fixture further comprising:
switch means in the circuitry and installed between the head and the body for turning the light source on and off on rotation of the head relative to the body.

18. The light fixture defined in claim 13 wherein the light source includes at least one light-emitting diode.

19. The light fixture defined in claim 13 wherein the head and body are provided with complementary screwthreads, the light fixture further comprising:
switch means in the circuitry and installed between the head and the body for turning the light source on and off on rotation of the head relative to the body.

20. The light fixture defined in claim 13 wherein the body is L-shaped and has an upper short leg carrying the head and shoulder fasteners and a chest part having a back face forming the holder surface.

21. The light fixture defined in claim 13 wherein the fastening means are suction cups or magnets.

22. The light fixture defined in claim 13, further comprising:
clamps or clips on outer ends of the arms.

23. The light fixture defined in claim 13 wherein the light fixture is humanoid and the body is formed as a torso.

24. The light fixture defined in claim 13 wherein the arms and legs are elastically deformable, whereby the fixture is possible.

25. A light fixture comprising:
a body shaped as a humanoid torso and having upper arm fasteners, lower leg fasteners, an upper neck fastener, and a back face forming an exposed holder surface;
arms and legs having inner ends releasably connectable to the respective fasteners;
means on outer ends of the legs for clinging to a surface;
a head fitted to the neck fastener;
an electric light source in the head;
a battery;
two contacts fixed in the body and oriented to hold the battery against the holder surface; and
circuitry between the contacts and the light source for powering the light source from the battery.
